(19) United States
(12) Patent Application Publication
(10) Pub. No.: US 2011/0047491 A1
(43) Pub. Date: Feb. 24, 2011

(54) USER INTERFACINIG METHOD USING TOUCH SCREEN IN MOBILE COMMUNICATION TERMINAL

(75) Inventors: Gwang Yoon HWANG, Pohang-si (KR); Won Seok CHOI, Yongin-si (KR)

Correspondence Address: Jae Y. Park, Kile Park Goekjian Reed & McManus PLLC, 1200 New Hampshire Ave. NW, Suite 570, Washington, DC, 20036, US

(73) Assignee: Company 100, Inc., Seongnam-si (KR)

(21) Appl. No.: 12/550,385

(22) Filed: Aug. 30, 2009

(30) Foreign Application Priority Data
Aug. 19, 2009 (KR) 10-2009-0076805

(51) Int. Cl. G06F 3/048

(52) U.S. Cl. 715/765; 715/810; 715/800

(57) ABSTRACT

The present invention relates to technology that allows a user to interface more conveniently when executing a web browser in a mobile communication terminal mounted with a touch screen, using polygonal static icons and dynamic icons. A zoom icon, an other page view icon, a move icon, a favorite icon, and an others icon are displayed as basic menu icons on a side of a touch screen, and sub menus of the menu icon selected from the basic menu icons are displayed on the touch screen in a specified pattern so as to allow a user to easily execute a web browser. Also, polygonal context menus are displayed around a point touched by a user on a touch screen, and operation of deploying corresponding sub menus in several directions in response to a touch to a certain menu by a user is implemented.

### BACKGROUND OF THE INVENTION

1. Field of the Invention

The present invention relates to technology that allows a user to interface more conveniently when executing a web browser in a mobile communication terminal mounted with a touch screen, and more particularly, to a user interfacing method using a touch screen in a mobile communication terminal, which allows a user to interface more conveniently using polygonal static icons and dynamic icons.

2. Description of the Related Art

In general, when using a web browser in a mobile communication terminal such as a mobile phone mounted with a touch screen, a user experiences a number of difficulties to input complicated commands through the touch screen. This is because a display device of a mobile communication terminal is much smaller than that of a general computer and has functionality inferior to the general computer.

Aside from these facts, since the user interface of a conventional web browser copies the interface of the general computer, it is difficult to touch menu icons smaller than a finger or a toucher (hereafter collectively referred to as the “toucher”), which leads to frequent occurrence of manipulation errors.

The user interface of the conventional web browser, which is installed and operated in a small-sized mobile communication terminal such as a mobile phone, adopts a pop-up menu system as in Microsoft Windows of a desk-top computer, such as Internet Explorer and Opera Mobile.

However, in such a system, since menu icons are smaller than the size of the toucher as described above, it is inconvenient to select a menu icon using the toucher. Also, when displaying sub menus of a specified menu, because the entire existing menus are continuously displayed, it is difficult to secure a sufficient space to display the sub menus.

A representative conventional user interface for coping with these disadvantages is an “iphone Safari.” In the iphone Safari, pop-up menus are displayed using most of a screen. Therefore, a user can conveniently select the pop-up menus.

Nevertheless, in the iphone Safari, because it does not support sub menus, it is difficult to execute complicated or various commands.

Further, in the above-described user interfaces, only an action (a click action) of pressing and releasing the toucher is admitted as an action for selecting a menu icon. Moreover, the one-dimensional motion of the toucher is limited within a visible region of a page, and the two-dimensional motion of the toucher is not considered at all.

Due to this fact, the user cannot select a menu icon in convenient various ways, by which it is difficult to realize a high quality user interface.

### SUMMARY OF THE INVENTION

Accordingly, the present invention has been made in an effort to solve the problems occurring in the related art, and an object of the present invention is to provide a user interfacing method using a touch screen in a mobile communication terminal, which displays basic menu icons on a side of a touch screen and displays sub menus of the menu icon selected from the basic menu icons on the touch screen in a specified pattern so as to allow a user to easily execute a web browser.

Another object of the present invention is to provide a user interfacing method using a touch screen in a mobile communication terminal, which displays polygonal context menus around a point touched by a user on a touch screen and repeatedly implements a necessary number of times operation of deploying corresponding sub menus in several directions in response to a touch to a certain menu by a user, so that a desired final menu can be selected.

In order to achieve the first object, according to one aspect of the present invention, there is provided a user interfacing method using a touch screen in a mobile communication terminal, comprising a basic menu displaying step of displaying a zoom icon, an other page view icon, a move icon, a favorite icon, and an others icon on a portion of a touch screen, as basic menu icons for a user interface used in a web browser of a mobile communication terminal; a zooming step of displaying a slider, which depicts a zooming rate of a current web page, on a side of the touch screen when the zoom icon is touched by a user, and zooming in and out a page in the browser depending upon a degree to which the slider is moved upwards/downwards by the user; an other page viewing step of displaying previous, current and next pages on a left side, a center portion and a left side, respectively, of the touch screen when the other page view icon is touched by the user, and translucently displaying “left/right move,” “page open,” “page close,” and “new page open” command regions over the displayed pages, so that a command can be executed in conformity with the user's choice; a page opening step of displaying a backward move icon and a forward move icon on left and right sides, respectively, of the move icon when the move icon is touched by the user, and selectively opening a corresponding page in conformity with a touch from the user; a favorite executing step of displaying icons of web pages, which are currently registered, in the shape of a ring or a portion of a ring when the favorite icon is touched by the user so that the user can rotate the icons clockwise or counterclockwise, and displaying a web page of an icon which is selected by the user; and an other menu executing step of displaying a save icon, a context icon, a select icon, a setting icon, and an open icon adjacent to the basic menu icons when the others icon is touched by the user, and executing a command for an icon which is selected by the user among the displayed icons.

In order to achieve the second object, according to another aspect of the present invention, there is provided a user interfacing method using a touch screen in a mobile communication terminal, comprising a first step of, when a user touches using a toucher an optional region on a touch screen of a mobile communication terminal, displaying context menu icons having the shape of a polygon, which are related with contents of the touched region, around the touched region; and a second step of, when one of the context menu icons is touched by the user, executing a command for the touched context menu icon, or deploying and displaying sub menu icons in respective directions of the touched context menu icon and then executing a command for a sub menu icon touched by the user among the sub menu icons or further deploying and displaying sub menu icons in respective directions of the sub menu icons.

### BRIEF DESCRIPTION OF THE DRAWINGS

The above objects, and other features and advantages of the present invention will become more apparent after a reading of the following detailed description taken in conjunction with the drawings, in which:

FIG. 1 is a view showing basic menu icons for interfacing a user on a web browser of a mobile communication terminal in accordance with an embodiment of the present invention;

FIG. 2 is a view showing a slider which indicates a zooming rate of a current web page according to the present invention;

FIG. 3 is a view showing a tab menu adopted in the present invention;

FIG. 4 is a view showing a move forward/backward menu adopted in the present invention;

FIG. 5 is a view showing a context menu adopted in the present invention;

FIG. 6 is a view showing a favorite menu adopted in the present invention;

FIG. 7 is a view showing a desired region select menu adopted in the present invention;

FIG. 8 is a view showing context menus in accordance with another embodiment of the present invention; and

FIG. 9 is a view illustrating a state in which the contact menus are deployed.

### DETAILED DESCRIPTION OF PREFERRED EMBODIMENTS

Reference will now be made in greater detail to preferred embodiments of the invention, examples of which are illustrated in the accompanying drawings. Wherever possible, the same reference numerals will be used throughout the drawings and the description to refer to the same or like parts.

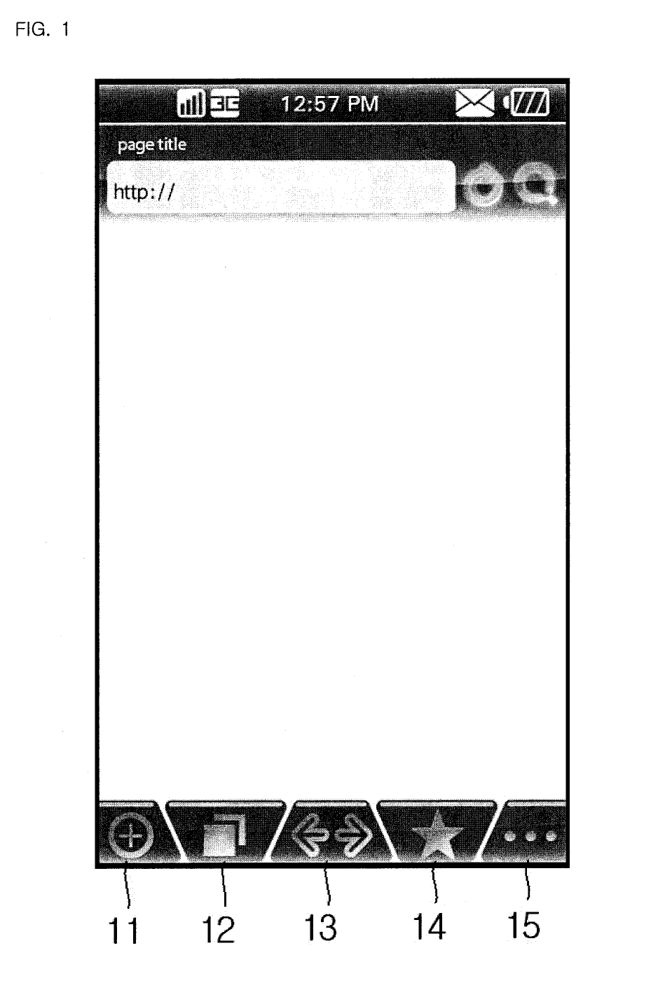

First, a user interfacing method in accordance with a first embodiment of the present invention, in which basic menu icons are displayed on a portion of a touch screen and sub menus of the menu icon selected from the basic menu icons are displayed on the touch screen in a specified pattern so as to allow a user to easily execute a web browser, will be described below with reference to FIGS. 1 through 7.

FIG. 1 is a view showing basic menu icons for a user interface used in a web browser of a mobile communication terminal in accordance with the embodiment of the present invention.

The basic menu icons include a zoom icon 11, an other page view icon 12, a move icon 13, a favorite icon 14, and an others icon 15. These basic menu icons are formed to have the shape of hexagons or portions of hexagons and are displayed on the lower end of the touch screen.

If a user touches using a toucher an optional icon among the basic menu icons 11 through 15 which are displayed on the lower end of the touch screen, sub menus of the corresponding icon are displayed on the screen immediately above the corresponding icon in a specified pattern, and a corresponding command is executed in conformity with the user's choice.

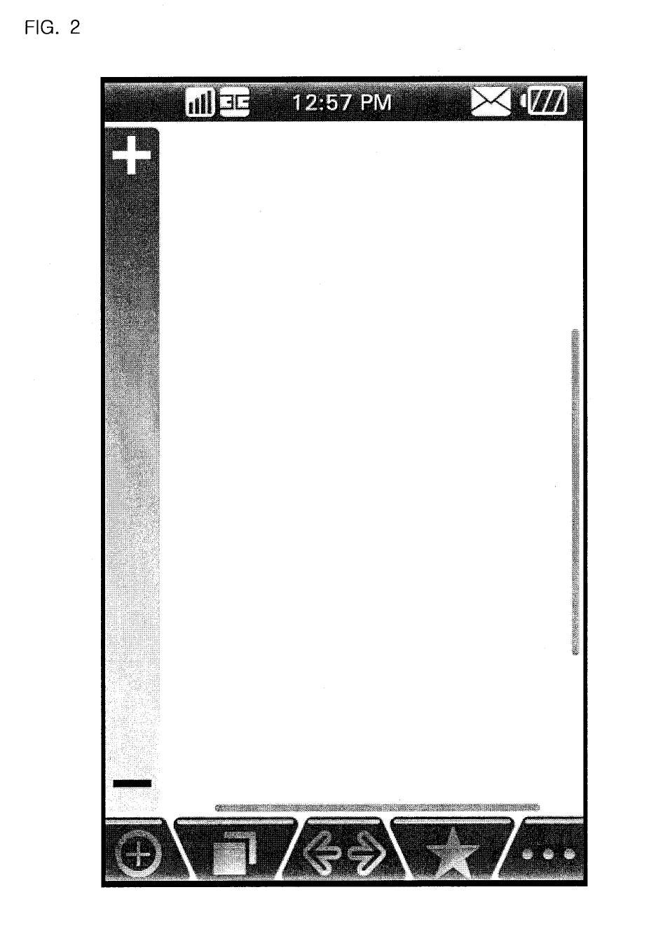

If the zoom icon 11 is touched among the basic menu icons by the user, as shown in FIG. 2, a slider which depicts the zooming rate of a current web page is displayed on a side (for example, a left side) of the screen. In this state, if the user moves the slider upwards/downwards using the toucher, the page in the browser is zoomed in or out.

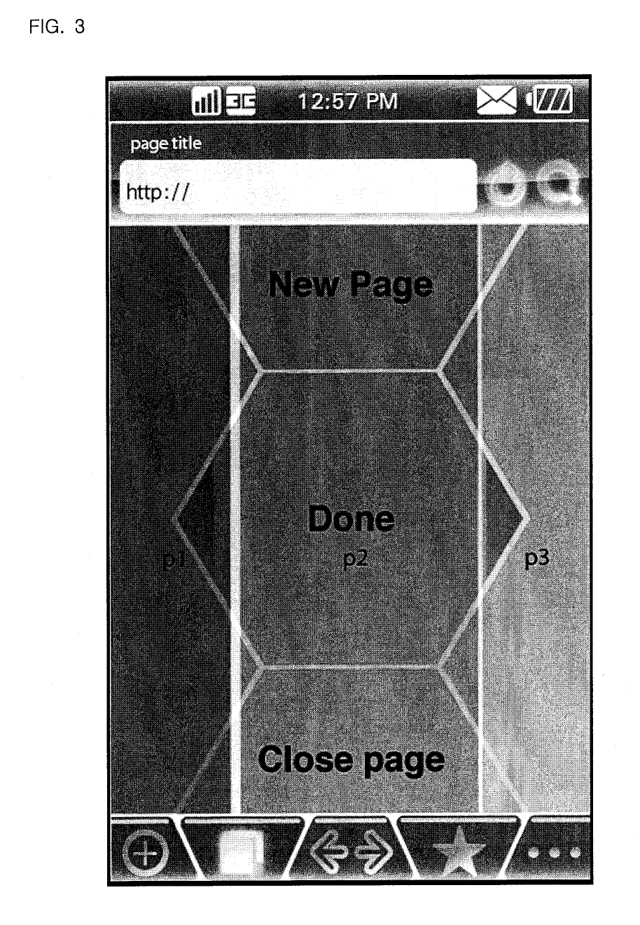

If the other page view icon 12 is touched among the basic menu icons by the user, as shown in FIG. 3, a web page P2 which is currently viewed is displayed on the center portion of the touch screen, and web pages P1 and P3 which are previously opened are displayed on a left side and a right side. Further, command regions including “left/right move,” “page open,” “page close,” and “new page open” commands are translucently displayed over the web pages P1 through P3. Accordingly, the user can recognize the contents of the web pages P1 through P3 which are displayed as a background screen.

In this state, the user can touch the command regions using the toucher and execute the “left/right move,” “page open,” “page close,” and “new page open” commands.

For example, if a central command region centrally formed in the shape of a complete hexagon is touched, the “page open” command is executed. If a left command region formed in the shape of a portion of a hexagon is touched, the “left move” command is executed. If a right command region formed in the shape of a portion of a hexagon is touched, the “right move” command is executed. If an upper command region formed in the shape of a half of a hexagon is touched, the “new page open” command is executed. If a lower command region formed in the shape of a half of a hexagon is touched, the “page close” command is executed.

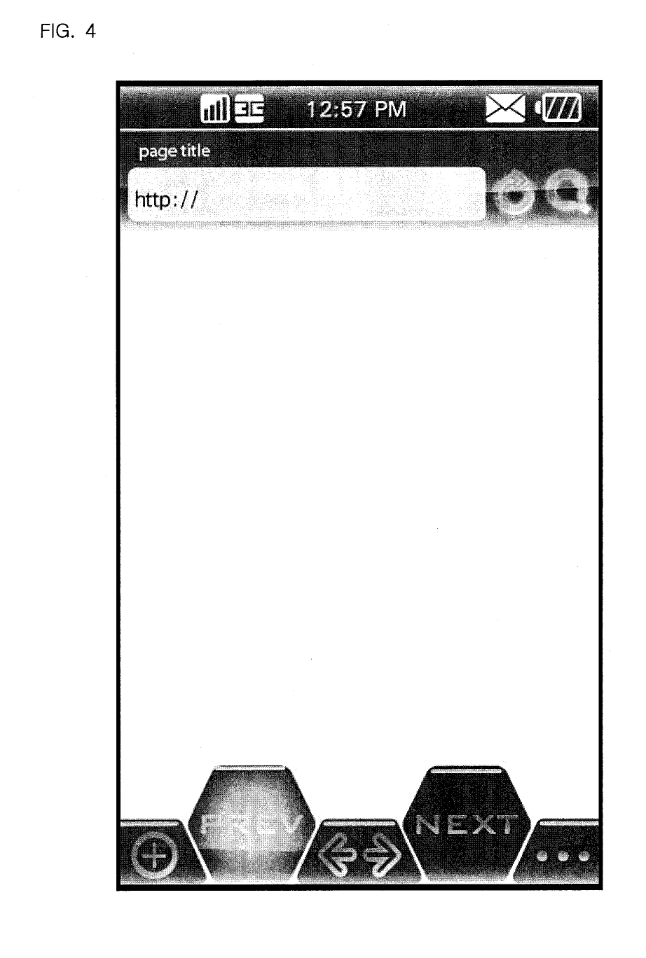

If the move icon 13 is touched among the basic menu icons by the user, as shown in FIG. 4, a backward move icon PREV which has the shape of a hexagon is displayed on a left side of the move icon 13, and a forward move icon NEXT which has the shape of a hexagon is displayed on a right side of the move icon 13.

In this state, if the user selectively touches the backward move icon PREV or the forward move icon NEXT or if the user touches the move icon 13 and then migrates to the backward move icon PREV or the forward move icon NEXT while maintaining the touch, a previous page or a next page is opened based on a current page.

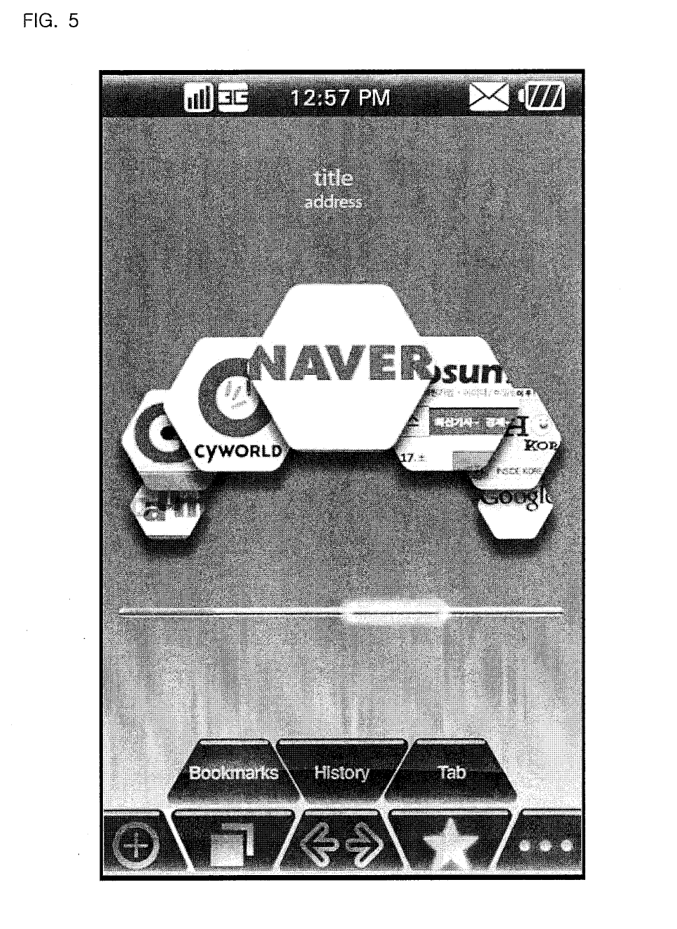

If the favorite icon 14 is touched among the basic menu icons by the user, as shown in FIG. 5, icons of web pages which are currently registered are displayed in the shape of a ring or a portion of a ring. In order to ensure the distinctiveness of the icons of the web pages, it is preferred that images capable of symbolically representing the corresponding web pages and addresses thereof be included.

To this end, in a web page registration stage, the user can extract an image from a web page currently viewed by the user, capable of symbolically representing the web page, store the image along with a title and an address, generate a web page icon of a desired shape, and add the generated web page icon to a favorite list. At this time, the shape of the web page icon can be realized in a variety of ways. Here, it is exemplified that the web page icon has a hexagonal shape.

In displaying the web page icons in the shape of a ring or a portion of a ring, in order for efficient display within a limited spatial area, the web page icons are displayed in a manner such that they are displayed to be most large when positioned at a forward center portion and to gradually decrease in size as they gradually go away from the forward center portion.

The address of a corresponding web page icon is displayed on a side (for example, an upper center portion) of the web page icons which define the shape of a ring or a portion of a ring.

In this state, the user can rotate clockwise or counterclockwise the web page icons which are displayed in the shape of a ring or a portion of ring, confirm a web page desired by him or her, and then select and open the corresponding web page by touching the corresponding icon.

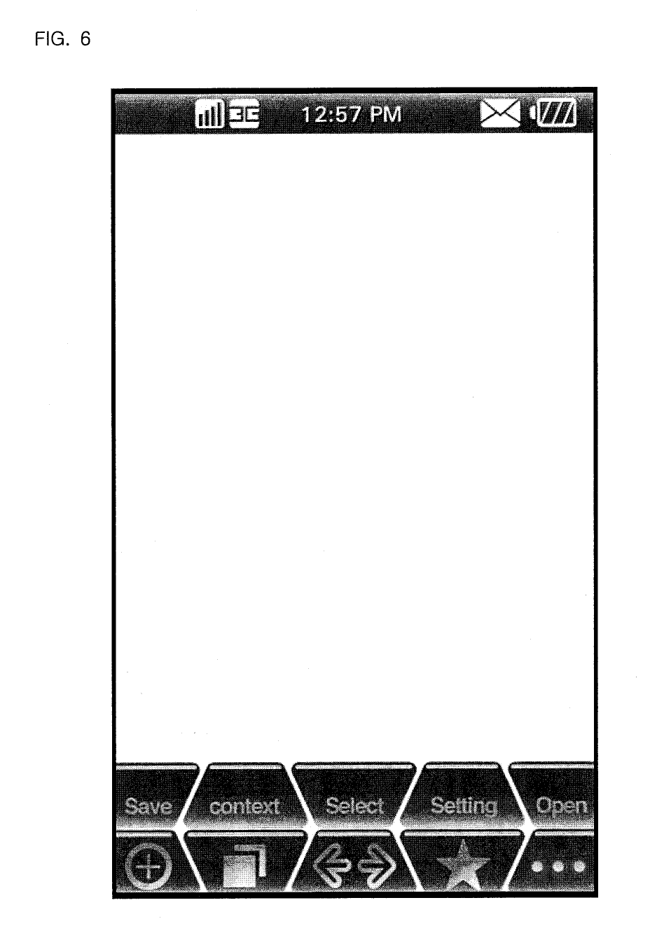

If the others icon 15 is touched among the basic menu icons by the user, as shown in FIG. 6, not frequently used icons, for example, a save icon Save, a context icon Context, a select icon Select, a setting icon Setting, and an open icon Open are displayed immediately on the basic menu icons 11 through 15.

The user can conveniently execute additional commands for the web page which is selected and read by him or her, using the save icon Save, the context icon Context, the select icon Select, the setting icon Setting, and the open icon Open.

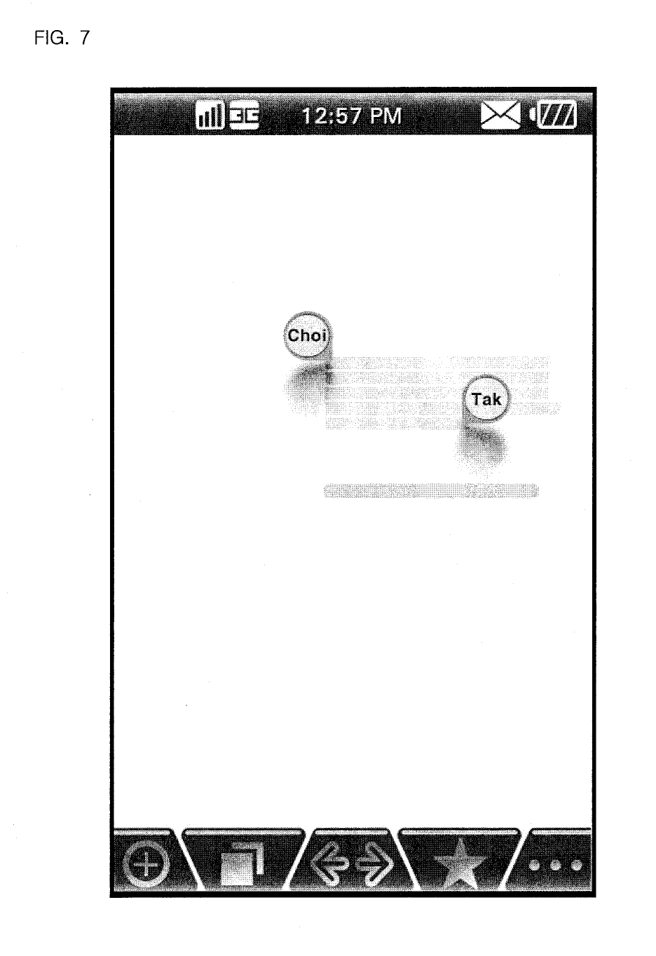

FIG. 7 is a view showing an embodiment of the present invention in which a starting point and an ending point of a desired region are selected by a select pin on a page displayed on the touch screen.

For example, if the user touches the select icon Select in FIG. 6, two select pins appear on the window of the touch screen as shown in FIG. 7. The user can draw one select pin of the two select pins to the starting point of a desired region and the other select pin of the two select pins to the ending point of the desired region. Thereupon, a starting letter and an ending letter are displayed on the head portions of the two select pins in such a way as to be easily recognized. In the illustrated display example, the starting letter is “Choi” and the ending letter is “Tak.”

The display contents of the touch screen may be letters, pictures, tables, mixtures thereof, etc.

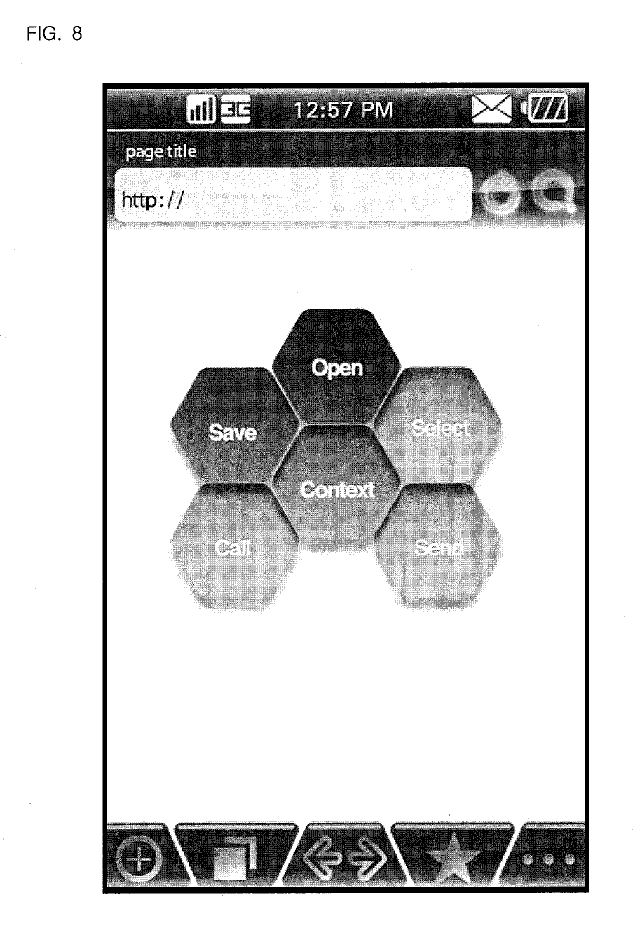

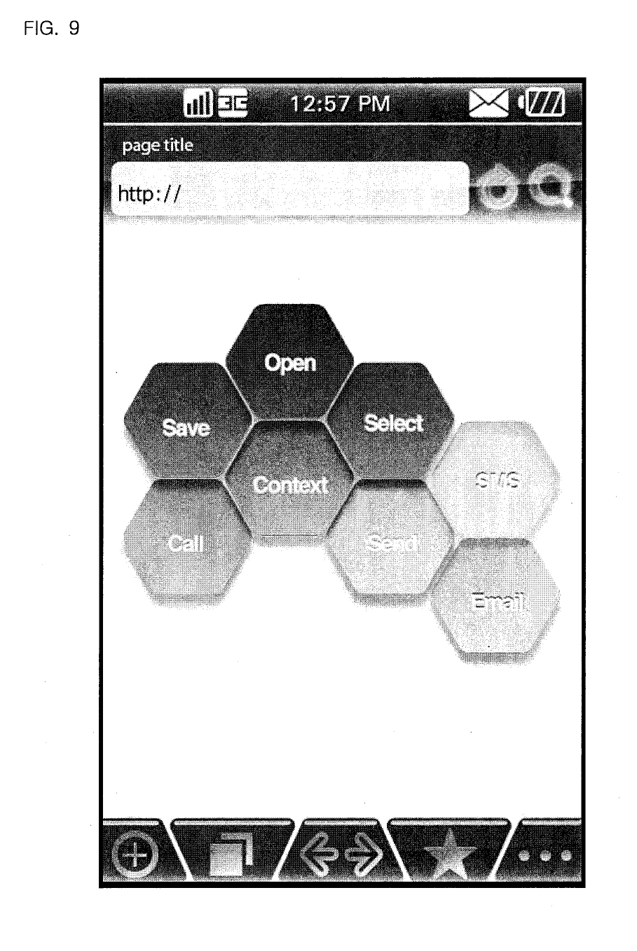

Next, a user interfacing method in accordance with a second embodiment of the present invention, in which polygonal context menus are displayed in such a way as to be deployed in respective corresponding directions in response to touches from a user, will be described below with reference to FIGS. 8 through 9.

FIG. 8 is a view showing context menus in accordance with the second embodiment of the present invention, and FIG. 9 is a view illustrating a way in which the contact menus are deployed.

If a user touches using a toucher an optional region among the contents displayed on a touch screen of a mobile communication terminal or touches long using a toucher a region where no contents are displayed, polygonal (for example, hexagonal) context menus are displayed as shown in FIG. 8. FIG. 8 exemplarily illustrates a state in which sub menu icons including Call, Save, Open, Select and Send icons are displayed by being deployed in five directions among the six directions of an uppermost context menu icon Context.

In the state in which the context menu icons are displayed on the touch screen as shown in FIG. 8, if the user touches an optional sub menu icon, for example, the send icon Send, as shown in FIG. 9, a short message icon SMS and an email icon Email are displayed as sub menu icons for the send icon Send. Accordingly, the user can send the contents prepared by him or her to a counterpart as a short message or an email.

In the state in which the context menu icons are displayed on the touch screen, when the user directly touches a desired context menu icon using the toucher or touches the touch screen from an outside and draws the toucher to the desired context menu icon while maintaining the touched state, the corresponding context menu icon is selected. However, if the touched state is released at a region of the touch screen where no context menu icon exists, the sub menu icons which are displayed immediately before in the deployed state disappear.

Hereafter, the context menu serving method when the user touches using the toucher an optional region among the contents displayed on the touch screen or touches long using the toucher a region where no contents are displayed will be described in detail.

If the user touches using the toucher a region of a phone number, a URL, an email address, a photograph or a previously selected document which cannot be edited, among the contents displayed on the touch screen, the context menu icons which are related with the contents of the touched region are displayed around the touched region.

Then, if the user touches using the toucher one of the displayed context menu icons, a command for the touched context menu icon is executed, or sub menu icons are displayed by being deployed in respective directions of the touched context menu icon.

After the sub menu icons are displayed, when the user touches one of the sub menu icons, a command for the touched sub menu icon is executed, or sub menu icons are displayed by being deployed in respective directions of the touched sub menu icon.

The operation of deploying and displaying sub menu icons in respective directions of the sub menu icons is repeated a necessary number of times.

For example, in the case where an open icon Open, an add icon Add, a remove icon Remove, a send icon Send, a copy icon Copy, a select icon Select, a paste icon Paste, a cut icon Cut, and a phone icon Phone are prepared as context menu icons, among these context menu icons, maximum six context menu icons which are related with the contents of the touched region are displayed around the touched region.

In this state, if the user draws the toucher to one icon of the six context menu icons while maintaining the touched state of the toucher or releases the touched state and then touches one of the six context menu icons, a command for the corresponding icon is executed.

In the case where sub menu icons of the icon selected among the six context menu icons exist, the sub menu icons are displayed by being deployed in the respective directions of the corresponding icon, and then, a command for a sub menu icon selected among the sub menu icons is executed.

In an example, if the user touches using the toucher a phone number that is displayed on the touch screen and is impossible to be edited, the add icon Add, the send icon Send, the copy icon Copy, and the phone icon Phone are displayed around the phone number. At this time, if the user touches the add icon Add using the toucher, a new address input box or an address input box already registered with a phone number is presented in conformity with the user's desire so that the phone number can be added.

In another example, if the user touches and selects the send icon Send among the context menu icons shown in FIG. 8 in order to send the contents viewed by the user on the touch screen, the short message icon a phone number that is displayed on the touch screen and is impossible to be edited, the short message icon SMS and the email icon Email are displayed as shown in FIG. 9 as sub menu icons for the send icon Send.

Thereafter, if the user selects the short message icon SMS, an input box is presented, and then, after the user inputs the phone number of a counterpart, the contents are sent to the phone number as a short message. If the user selects the email icon Email, an input box is presented, and then, after the user inputs the email address of the counterpart, the contents are sent to the email address.

In a state in which no contents are selected among the contents displayed on the touch screen, if the user touches long using the toucher a region where no contents are displayed, context menu icons which are related with the entire contents displayed on a corresponding page are translucently displayed.

In this state, a command for the context menu icon selected by the user can be executed, or, as described above, after repeating a necessary number of times the operation of deploying and displaying sub menu icons in respective directions, a command for the sub menu icon finally selected by the user is executed.

As a result, after deploying and displaying sub menu icons in respective directions of a context menu icon, the operation of deploying and displaying sub menu icons in respective directions of a touched sub menu icon is repeated a necessary number of times. At this time, a two-dimensional path (gesture), along which the user migrates toward a desired sub menu using the toucher, is checked, and then, which sub menu icon is finally selected by the user is confirmed, so that a corresponding command can be executed.

As is apparent from the above description, the present invention provides advantages in that basic menu icons are displayed on a side of a touch screen and sub menus of the menu icon selected from the basic menu icons are displayed on the touch screen in a specified pattern so as to allow a user to easily execute a web browser, whereby user convenience can be improved.

Also, in the present invention, polygonal context menus are displayed around a point touched by a user on a touch screen, and operation of deploying corresponding sub menus in several directions in response to a touch to a certain menu by a user is repeatedly implemented a necessary number of times, whereby various menus can be easily selected and executed on the touch screen having a narrow area.

Although preferred embodiments of the present invention have been described for illustrative purposes, those skilled in the art will appreciate that various modifications, additions and substitutions are possible, without departing from the scope and the spirit of the invention as disclosed in the accompanying claims.

1. A user interfacing method using a touch screen in a mobile communication terminal, comprising:
a basic menu displaying step of displaying a zoom icon, an other page view icon, a move icon, a favorite icon, and an others icon on a portion of a touch screen, as basic menu icons for a user interface used in a web browser of a mobile communication terminal;
a zooming step of displaying a slider, which depicts a zooming rate of a current web page, on a side of the touch screen when the zoom icon is touched by a user, and zooming in and out a page in the browser depending upon a degree to which the slider is moved upwards/downwards by the user;
an other page viewing step of displaying previous, current and next pages on a left side, a center portion and a left side, respectively, of the touch screen when the other page view icon is touched by the user, and translucently displaying “left/right move,” “page open,” “page close,” and “new page open” command regions over the displayed pages, so that a command can be executed in conformity with the user's choice;
a page opening step of displaying a backward move icon and a forward move icon on left and right sides, respectively, of the move icon when the move icon is touched by the user, and selectively opening a corresponding page in conformity with a touch from the user;
a favorite executing step of displaying icons of web pages, which are currently registered, in the shape of a ring or a portion of a ring when the favorite icon is touched by the user so that the user can rotate the icons clockwise or counterclockwise, and displaying a web page of an icon which is selected by the user; and
an other menu executing step of displaying a save icon, a context icon, a select icon, a setting icon, and an open icon adjacent to the basic menu icons when the others icon is touched by the user, and executing a command for an icon which is selected by the user among the displayed icons.

2. The user interfacing method according to claim 1, wherein the basic menu icons have the shape of hexagons or portions of hexagons.

3. The user interfacing method according to claim 1, wherein, in the favorite executing step, when displaying the icons of the web pages in the shape of a ring or a portion of a ring, images capable of symbolically representing the corresponding web pages and addresses thereof are displayed together.

4. The user interfacing method according to claim 1, wherein, in the favorite executing step, when displaying the icons of the web pages in the shape of a ring or a portion of a ring, the icons are displayed to be most large when positioned at a forward center portion and to gradually decrease in size as they go away from the forward center portion.

5. The user interfacing method according to claim 1, wherein, in the other menu executing step, when the select icon is selected, two select pins are provided, so that the user can draw one select pin to designate a starting point of a desired region and the other select pin to designate an ending point of the desired region.

6. A user interfacing method using a touch screen in a mobile communication terminal, comprising:
a first step of, when a user touches using a toucher an optional region on a touch screen of a mobile communication terminal, displaying context menu icons having the shape of a polygon, which are related with contents of the touched region, around the touched region; and
a second step of, when one of the context menu icons is touched by the user, executing a command for the touched context menu icon, or deploying and displaying sub menu icons in respective directions of the touched context menu icon and then executing a command for a sub menu icon touched by the user among the sub menu icons or further deploying and displaying sub menu icons in respective directions of the sub menu icons.

7. The user interfacing method according to claim 6, wherein the polygon comprises a hexagon.

8. The user interfacing method according to claim 6, wherein the first step comprises the step of, when the user touches long a region where no contents are displayed while selecting no contents among contents displayed on the touch screen, translucently displaying context menu icons which are related with the entire contents displayed on a corresponding page.

9. The user interfacing method according to claim 6, wherein the touched region in the first step includes at least one of regions of a phone number, a URL, an email address, a photograph, and a previously selected document.

10. The user interfacing method according to claim 6, wherein the context menu icons includes at least one of an open icon, an add icon, a remove icon, a send icon, a copy icon, a select icon, a paste icon, a cut icon, and a phone icon.

11. The user interfacing method according to claim 6, wherein the second step comprises the step of repeating a necessary number of times operation of deploying and displaying sub menu icons in respective directions of a touched sub menu icon and executing a command for a sub menu icon finally selected by the user.

12. The user interfacing method according to claim 6, wherein the second step comprises the step of checking a path along which the user migrates on the touch screen while maintaining a touched state of the toucher and executing a command for a sub menu icon which is finally selected by the user.

13. The user interfacing method according to claim 6, wherein the toucher includes a finger.

14. The user interfacing method according to claim 12, wherein the toucher includes a finger.
